(19) United States
(12) Patent Application Publication
(10) Pub. No.: US 2024/0126500 A1
(43) Pub. Date: Apr. 18, 2024

(54) DEVICE AND METHOD FOR CREATING A SHARABLE CLIP OF A PODCAST

(71) Applicant: AIRR, INC., Wilmington, DE (US)

(72) Inventors: Michael SANTER, Pismo Beach, CA (US); Samuel RUKEYSER, Rye, NY (US); David LU, Houston, TX (US)

(21) Appl. No.: 17/769,450

(22) PCT Filed: Oct. 20, 2020
(86) PCT No.: PCT/US2020/056463

§ 371 Date: Apr. 15, 2022

Related U.S. Application Data
(60) Provisional application No. 62/923,990, filed on Oct. 21, 2019.

(51) Int. Cl. G06F 3/16

(52) U.S. Cl. CPC G06F 3/167

(57) ABSTRACT

Provided is system and method for creating and sharing clips of podcasts. The system enables creation of a clip from a podcast episode for personal reference and/or for sharing with others. Clips can be created and shared using a visual interface or a voice interface. The context of the clip can be maintained with respect to the source episode and allows the originator of the audio content or others to add more information to the clip via text or audio. Furthermore, the disclosed system and method allow users to more easily find interesting or relevant clips from podcast episodes.

### RELATED APPLICATION

The present application claims priority to, and the benefit of, U.S. Provisional Patent Application No. 62/923,990 entitled “DEVICE AND METHOD FOR CREATING A SHARABLE CLIP OF A PODCAST” and filed Oct. 21, 2019, which is hereby incorporated by reference in its entirety.

### FIELD

The present disclosure generally relates to audio media such as podcasts and, in particular, to apps, devices, and methods for creating and sharing a clip of a portion of an audio media episode.

### BACKGROUND

Podcasts are an increasingly popular medium for distributing and updating audio content over the internet. Podcasts are available from provider websites, for example, and are typically provided to users or subscribers as Really Simple Syndication (RSS) feeds. Various user devices, such as computers, laptops, tablets, and cell phones can be used for receiving these RSS feeds.

Because podcasts are typically delivered as RSS feeds, it is difficult to capture only a portion of the podcast. Additionally, sharing a podcast typically involves sharing (via, for example, email, message, Twitter, or Facebook) the entire podcast. Once shared, no easily accessible mechanism exists to allow users to comment on the episode.

### SUMMARY

According to various embodiments, a method of providing a clip of a podcast episode by a podcast clip server is disclosed. The method includes: receiving, by the podcast clip server and from a first instance of an app executing on a computing device, a request to generate a clip of a podcast episode, the request including data identifying the clip of the podcast episode; generating a clip ID corresponding to the data identifying the clip of the podcast episode; storing in persistent electronic memory the clip ID in association with the data identifying the clip of the podcast episode; and providing at least the clip ID to the first instance of the app executing on the computing device, whereby a user of the first instance of the app executing on the computing device obtains a link to the clip of the podcast episode.

Various optional features of the above embodiments include the following. The data identifying the clip of the podcast episode may include: a podcast episode ID, an identification of a temporal starting point within the podcast episode, and an identification of a temporal ending point within the podcast episode. The data identifying the clip of the podcast episode may include an RSS link to a podcast server that hosts the podcast episode. The method may include: receiving a request, by the podcast clip server and from a second instance of the app executing on a second computing device, for the podcast clip, where the request includes the podcast clip ID; retrieving the data identifying the clip of the podcast episode; and providing the data identifying the clip of the podcast episode to the second instance of the app executing on a second computing device. The request may further include commentary on the podcast clip, and the method may further include storing in persistent electronic memory the commentary on the podcast clip in association with the data identifying the clip of the podcast episode. The commentary may include audio commentary.

According to various embodiments, a system for providing a clip of a podcast episode by a podcast clip server is disclosed. The system includes a podcast clip server communicatively coupled to a computer network and configured to perform operations including: receiving, from a first instance of an app executing on a computing device, a request to generate a clip of a podcast episode, the request including data identifying the clip of the podcast episode; generating a clip ID corresponding to the data identifying the clip of the podcast episode; storing in persistent electronic memory the clip ID in association with the data identifying the clip of the podcast episode; and providing at least the clip ID to the first instance of the app executing on the computing device, whereby a user of the first instance of the app executing on the computing device obtains a link to the clip of the podcast episode.

Various optional features of the above embodiments include the following. The data identifying the clip of the podcast episode may include: a podcast episode ID, an identification of a temporal starting point within the podcast episode, and an identification of a temporal ending point within the podcast episode. The data identifying the clip of the podcast episode may include an RSS link to a podcast server that hosts the podcast episode. The operations may further include: receiving a request, from a second instance of the app executing on a second computing device, for the podcast clip, where the request includes the podcast clip ID; retrieving the data identifying the clip of the podcast episode; and providing the data identifying the clip of the podcast episode to the second instance of the app executing on a second computing device. The request may further include commentary on the podcast clip, and the operations may further include storing in persistent electronic memory the commentary on the podcast clip in association with the data identifying the clip of the podcast episode. The commentary may include audio commentary.

According to various embodiments, a computer-implemented method of creating a clip of a podcast episode is disclosed. The method includes: receiving at least one instruction from a user to generate the clip of the podcast episode, the at least one instruction including an identification of a starting point within the podcast episode and an identification of an ending point within the podcast episode; sending to a podcast clip server a request to generate the clip of the podcast episode, the request including data identifying the clip of the podcast episode, the data identifying the clip of the podcast episode including the identification of the starting point within the podcast episode, and the identification of the ending point within the podcast episode, whereby the podcast clip server generates a clip ID and stores the clip ID in persistent electronic memory in association with the data identifying the clip of the podcast episode; receiving, from the podcast clip server, the clip ID; and converting the clip ID to a link to the clip of the podcast episode.

Various optional features of the above embodiments include the following. The data identifying the clip of the podcast episode may include: a podcast episode ID. The data identifying the clip of the podcast episode may include an RSS link to a podcast server that hosts the podcast episode. The method may further include: receiving an instruction from the user to forward the link to the clip of the podcast episode to a user of the app; and forwarding, in response to the receiving the instruction, at least the podcast clip ID to the user of the app. The request may further include commentary on the podcast clip. The commentary may include audio commentary. The method may further include displaying an at least partial transcript of the podcast episode, where the identification of the starting point within the podcast episode includes an identification of the starting point within the podcast episode on the at least partial transcript, and the identification of the ending point within the podcast episode may include an identification of the ending point within the podcast episode on the at least partial transcript. The receiving the at least one instruction from the user to generate the clip of the podcast episode may include receiving from the user a selection of a portion of the at least partial transcript of the podcast episode, where the starting point within the podcast episode includes a beginning of the selection, and where the ending point within the podcast episode includes an ending of the selection. The receiving the at least one instruction from the user to generate the clip of the podcast episode may include receiving at least one instruction via a voice interface. The operations may further include: receiving search criteria from the user; and displaying an identification of at least one podcast clip that matches the search criteria. The operations may further include: displaying a plurality of podcast clip categories; receiving a selection of at least one podcast clip from the user based on at least one category of the plurality of podcast clip categories; and providing the at least one podcast clip to the user.

According to various embodiments, an electronic system for creating a clip of a podcast episode is disclosed. The electronic system includes at least one electronic processor and at least one electronic persistent memory communicatively coupled to the at least one electronic processor and storing computer readable instructions that, when executed by the at least one electronic processor, configure the at least one electronic processor to perform operations including: receiving at least one instruction from a user to generate the clip of the podcast episode, the at least one instruction including an identification of a starting point within the podcast episode and an identification of an ending point within the podcast episode; sending to a podcast clip server a request to generate the clip of the podcast episode, the request including data identifying the clip of the podcast episode, the data identifying the clip of the podcast episode including the identification of the starting point within the podcast episode, and the identification of the ending point within the podcast episode, whereby the podcast clip server generates and a clip ID and stores the clip ID in persistent electronic memory in association with the data identifying the clip of the podcast episode; receiving, from the podcast clip server, the clip ID; and converting the clip ID to a link to the clip of the podcast episode.

Various optional features of the above embodiments include the following. The data identifying the clip of the podcast episode may include: a podcast episode ID. The data identifying the clip of the podcast episode may include an RSS link to a podcast server that hosts the podcast episode. An app may include the computer readable instructions, and the operations may further include: receiving an instruction from the user to forward the link to the clip of the podcast episode to a user of the app; forwarding, in response to the receiving the instruction, at least the podcast clip ID to the user of the app. The request may further include commentary on the podcast clip. The commentary may include audio commentary. The operations may further include displaying an at least partial transcript of the podcast episode, where the identification of the starting point within the podcast episode includes an identification of the starting point within the podcast episode on the at least partial transcript, and where the identification of the ending point within the podcast episode includes an identification of the ending point within the podcast episode on the at least partial transcript. The receiving the at least one instruction from the user to generate the clip of the podcast episode may include receiving from the user a selection of a portion of the at least partial transcript of the podcast episode, where the starting point within the podcast episode includes a beginning of the selection, and where the ending point within the podcast episode includes an ending of the selection. The receiving the at least one instruction from the user to generate the clip of the podcast episode may include receiving at least one instruction via a voice interface. The operations may further include: receiving search criteria from the user; and displaying an identification of at least one podcast clip that matches the search criteria. The operations may further include: displaying a plurality of podcast clip categories; receiving a selection of at least one podcast clip from the user based on at least one category of the plurality of podcast clip categories; and providing the at least one podcast clip to the user.

### BRIEF DESCRIPTION OF THE DRAWINGS

The accompanying drawings, which are incorporated in and constitute a part of this specification, illustrate the present disclosure and together with the description, serve to explain the principles of the present disclosure.

FIG. 1 depicts a user interface for requesting creation of a clip of a podcast episode according to various embodiments;

FIG. 2 graphically depicts a presentation screen for a clip of a podcast, including an audio file, a text of the clip, and comments on the clip by other podcast listeners, according to various embodiments;

FIG. 3 depicts a method for creating a clip of a podcast according to various embodiments; and

FIG. 4 depicts a system for creating a clip of a podcast according to various embodiments;

FIG. 5 depicts podcast clip sharing screens according to various embodiments; and

FIG. 6 depicts a podcast clip search screen according to various embodiments.

### DETAILED DESCRIPTION

Reference will now be made in detail to exemplary implementations of the present disclosure, examples of which are illustrated in the accompanying drawings. Wherever possible, the same reference numbers will be used throughout the drawings to refer to the same or like parts. In the following description, reference is made to the accompanying drawings that form a part thereof, and in which is shown by way of illustration specific exemplary implementations in which the present disclosure can be practiced. These implementations are described in sufficient detail to enable those skilled in the art to practice the present disclosure and it is to be understood that other implementations can be utilized and that changes can be made without departing from the scope of the present disclosure. The following description is, therefore, merely exemplary.

It would be desirable to easily capture a clip of a portion of a podcast, share that clip with others, and allow comments about the clip to be created and shared. The disclosed apps, devices and methods enable creation of a clip from a podcast episode for personal reference and/or for sharing with others. Clips can be created and shared using a visual interface or a voice interface. Some disclosed embodiments allow the context of the clip to be maintained with respect to the source episode and allow the originator of the audio content or others to add more information to the clip via text or audio. Furthermore, some disclosed embodiments allow users to more easily find interesting or relevant clips from podcast episodes.

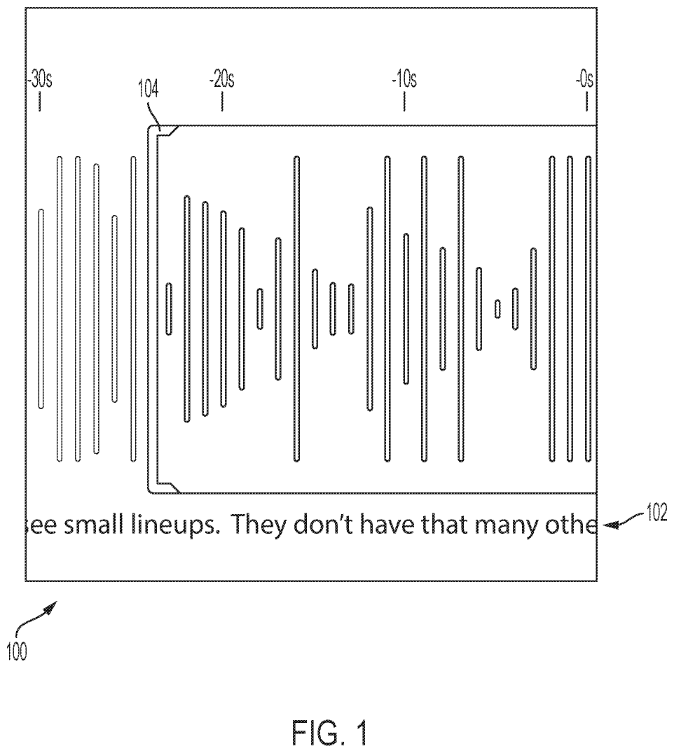

Referring to FIG. 1, a portion of a user interface 100 is shown that allows a user to easily request creation and sharing of a clip from a podcast episode while listening. The interface 100 may be present on a clip client app, e.g., executing on a smart phone, tablet, or computer. According to some embodiments, when the user decides to create a clip, they are able to press and hold a button 102 and view a transcript 104 of the podcast episode. The user may then scrub backwards to select the desired starting time for the clip. In general, the user may use a graphical interface, e.g., a graphical user interface or “GUI”, or their voice, e.g., a vocal interface, to create and share a clip. Thus, clip creation request techniques are not limited to pressing, holding, and scrubbing on a transcript as described above.

The transcript may be generated using a speech-to-text converter, which may be implemented in software. Such an interface may be included in the clip client app according to some embodiments, and/or may be accessed as a remote internet connected service, e.g., in a cloud server environment, according to some embodiments.

Some embodiments that include a speech-to-text converter may further include a sentence parser. The sentence parser may accept textual output from the text-to-speech converter and output textual parsed sentences. Like the text-to-speech converter, the sentence parser may be implemented within the clip client app or remotely, e.g., in a cloud server environment. The sentence parser may be implemented as a trained machine learning classifier, e.g., as a neural network. The output of the sentence parser may be used as the transcript displayed to the user. According to some embodiments, including a sentence parser provides more accurate transcripts. Further, embodiments that include a sentence parser may be better able to identify the starting point and ending point of the clip. For example, such embodiments may insert parsing characters, which are not displayed to users, between sentences. When a user selects a starting or ending location that is near such a parsing character, such embodiments may snap to the location between sentences as a convenience to users.

Any of a variety of GUI transcript-based clip creation request techniques may be employed. According to various embodiments, the user may request creation of a clip by highlighting a respective portion of the transcript. The audio corresponding to the highlighted transcript portion is then used for the clip.

For transcript-based clip creation, the clip client app may recommend transcript portions based on past actions of other clip client app users. For example, if a particular sentence, phrase, or transcript portion gets frequently identified as a clip, when a user starts to select a clip, e.g., by pressing a holding on a transcript portion, the clip client app may highlight as a suggestion the frequently-created clip transcript portion and present a popup message asking the user whether they wish to use the suggestion as a clip. Alternately, the frequently-identified portion may be highlighted in the transcript when the user first attempts to select a clip.

Any of a variety of techniques may be used to request creation of a clip from the podcast episode audio without involving a transcript. According to various embodiments, the user may request creation of a clip through the use of a button on the user's headphones. According to such embodiments, any of a variety of such buttons may be used, e.g., a next track or previous track button. According to various embodiments, the button may be tapped once to begin the clip and a second time to end the clip. Alternately, the button may be tapped to begin the clip, held down to continue the clip, and released to end the clip.

According to various embodiments, the user is able to request creation of a clip through a voice interface. The voice interface may be integrated into the clip client app or may be a separate voice interface in communication with the app. If separate, the voice interface may be a part of a personal digital voice assistant, such as ALEXA, SIRI, or CORTANA. In such embodiments, the clip client app may communicate with the personal digital voice assistant using an interface, such as an Application Program Interface (API) of the personal digital voice assistant. The user may use their voice to select the desired starting point for the clip. For example, the user may request creation of a clip by requesting that a clip be saved from when the speaker of the audio content says a certain word or phrase, e.g., “save a clip from when the podcast hosts says, interesting detail.—These clips are then able to be shared by the user to others, e.g., using a link.

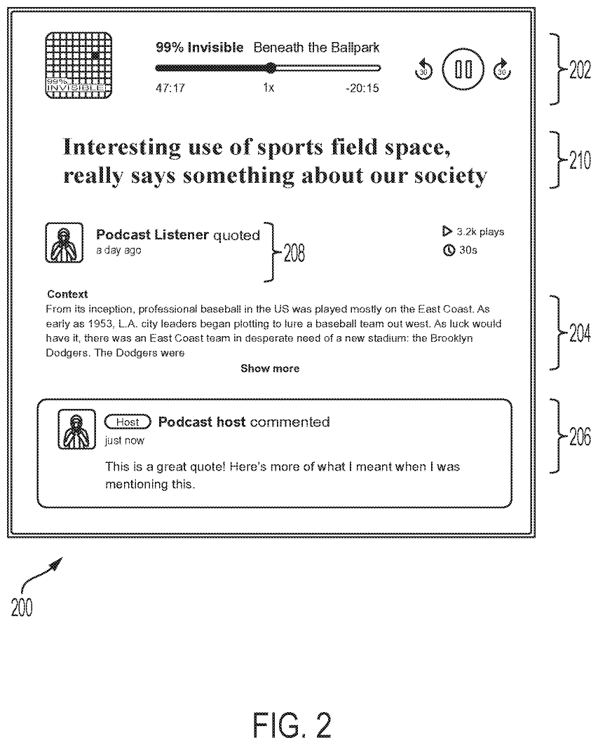

FIG. 2 graphically depicts a portion of a presentation screen 200 for a clip of a podcast, including audio file player controls 202, a transcript 204 of the clip, comments 206 on the clip by other podcast listeners, and comments 210 on the clip by the user that requested its creation, according to various embodiments. Screen 200 further identifies the user 208 that generated the clip. The audio file player controls 202 may include controls such as play, pause, go back thirty seconds, and go forward thirty second. Thus, presentation screen 200 may include an audio player and its graphical user interface.

Presentation screen 200 may be displayed when a user receives a link to the clip and navigates to the link in a web browser, for example. Thus, the presentation screen 200 may be in the form of a web page outfitted with an audio player. Alternately, presentation screen 200 may be displayed within the clip client app when the user is playing a clip. Thus, the presentation screen 200 may be implemented by the clip client app and include an audio player.

Note that, according to some embodiments, presentation screen includes a video player and associated controls. In such embodiments, the podcast clip audio plays in the video player. In addition, the video player may display video images, e.g., an animated clip timer, which may be in a decorative shape. Further, such embodiments may allow the user that requested the creation of the clip to insert badges, icons, or other video image content into the video as the clip plays.

The transcript 204 may be a partial transcript. More particularly, some embodiments enable the context of the clip to be maintained when it is shared. For example, when a user views a clip, such embodiments may display a transcript 204 of context surrounding the clip on one or both sides, and possibly including all or a portion of the clip. That is, transcript 204 from the sections of audio immediately, e.g., twenty seconds, before and/or after the clip may be provided to prevent the originator from being taken out of context. To produce the transcript, some embodiments may include or interface with a speech-to-text converter, which may be implemented in software as described above in reference to FIG. 1. Such a speech-to-text converter may be included in some embodiments, and may be accessed as a remote internet connected service according to other embodiments as described above.

As depicted in FIG. 2, some embodiments allow the originator of the content, a guest, or any user of the clip client app to add commentary in the form of additional text, audio, or video to the clip. After a user views a clip, the user may then add additional information or provide commentary in the form of an audio, video, or text reply. This feature allows the originator of the audio content or another user to clarify, provide further information, or extend the conversation based on the clip. FIG. 2, above, depicts textual comments 210 from the user that generated the clip at the top, and further comments 206 added to the clip later by the podcast host at the bottom.

Audio and video comments may be implemented in any of a variety of way according to various embodiments. For video commentary, the presentation screen (e.g., 200) may include a video player. According to some embodiments, audio or video comments automatically play before or after the clip. According to some such embodiments, the clip creator may select whether the comments play before or after the clip. Further according to some such embodiments, the comments may be inserted with a cross-fade effect. According to some embodiments, audio or video comments have a separate play button that may be activated at any time separate from the podcast episode clip. According to some embodiments, the user can select (e.g., from a displayed list) pre-recorded background music to be inserted under the user's audio or video comments.

According to some embodiments, the audio commentary is transcribed (e.g., using the speech-to-text converter described above in reference to FIG. 1) and the transcription is presented to the viewer, e.g., on a presentation screen such as the presentation screen 200 of FIG. 2. According to some embodiments, the audio of any video commentary is transcribed and presented in this manner.

According to some embodiments, the clip client app includes a comment recording feature, such as a record button, through which the user can record an audio or video comment. According to some embodiments, the user can upload any pre-recorded audio or video comment, in any of a variety of audio file formats, to the clip client app for usage as a comment on a clip.

Users can become aware of comments in a variety of ways. According to some embodiments, whenever a user comments on a podcast episode, the host of the episode receives a push notification through the clip client app that a new comment on their episode is available. According to some embodiments, when a user views a podcast episode in a playback window of the clip client app, the window displays links to all (or any subset) of available comments for the episode.

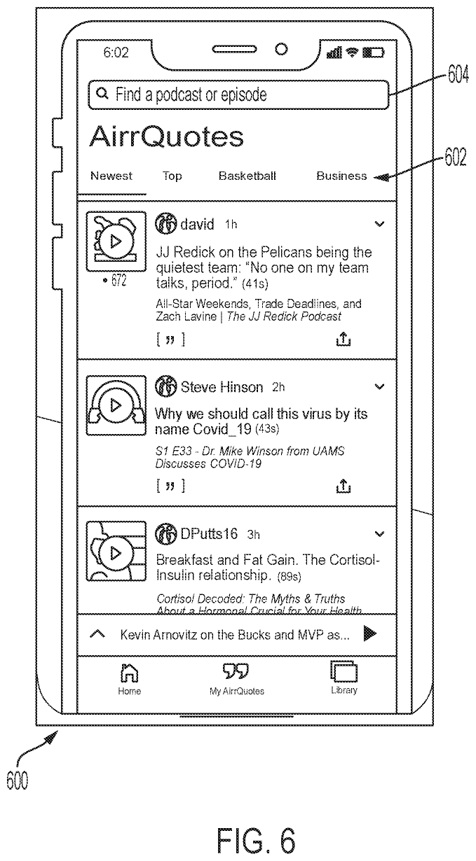

According to some embodiments, real-time comments may be provided in any of a variety of ways. According to some embodiments, the clip client app may include direct messaging capability, for every user or only for clip social media accountholders (described below in reference to FIG. 6). According to some embodiments, the clip client app provides group chatrooms, which may allow for textual, audio, or video real-time communications. According to any of these embodiments, the clip client app may allow for playing the clip in the direct messaging window or group chatroom in a synchronous manner for the participants. According to any of these embodiments, the group chatrooms may be limited in time, e.g., to 90 seconds, such that users know beforehand that their time will not be excessively taken up.

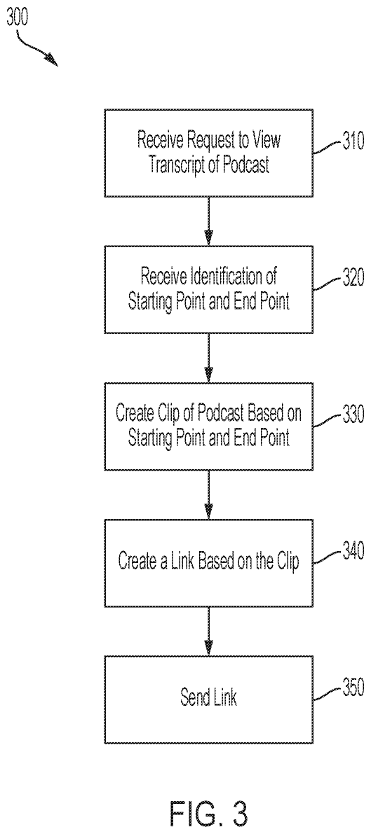

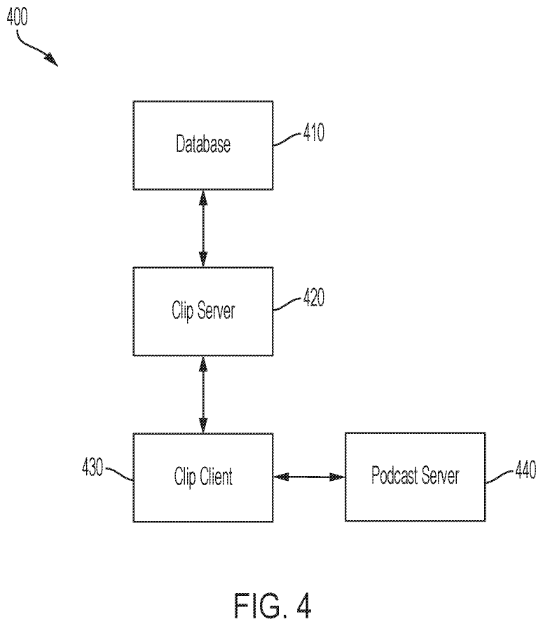

FIG. 3 depicts a method 300 for creating a clip of a podcast according to various embodiments. Method 300 may be implemented at least partially by an app, e.g., a clip client app executing on a smart phone. According to some embodiments, method 300 is implemented using system 400 of FIG. 4.

At 310 a request to view a transcript of a podcast is received at a server from a first user, e.g., via a user interface for a clip client app on the user's computing device as shown and described herein in reference to FIG. 1. Note that the action of block 310 are optional, e.g., in embodiments in which the user requests clip creation using a technique that does not involve a transcript.

At 320, the user identifies a starting point and an end point within the podcast for which a clip is to be created. The user can specify a starting point and an endpoint on the transcript requested at 310 as it appears on the user interface, e.g., in a manner as shown and described above in reference to FIG. 1. Alternately, or in addition, the user can specify a starting point and an endpoint by identifying a start and end time in the podcast or identifying a start and end point by voice, e.g., as shown and described herein in reference to FIG. 2.

At 330, a clip of the podcast episode is created, e.g., by the clip server. According to some embodiments, the clip is created in two (or more) stages by first generating a clip ID corresponding to data identifying the clip of the podcast episode and then second storing in persistent electronic memory the clip ID, as well as any user commentary, in association with the data identifying the clip of the podcast episode. Embodiments that include video commentary may further store any badges, icons, or other video image data in association with the clip ID.

The clip ID may be any of a variety of forms. According to some embodiments, the clip ID is a serial number provided sequentially by the clip server. According to some embodiments, the clip ID is a random number. According to some embodiments, the clip ID is a cryptographic hash (e.g., SHA-256) of data identifying the clip of a podcast episode. Suh data may be provided from the user's computing device to the clip server and may include any, or any combination, of: a podcast ID, a podcast episode ID, an identification of a starting point (e.g., a temporal starting point) within the podcast episode, and/or an identification of a ending point (e.g., a temporal ending point) within the podcast episode.

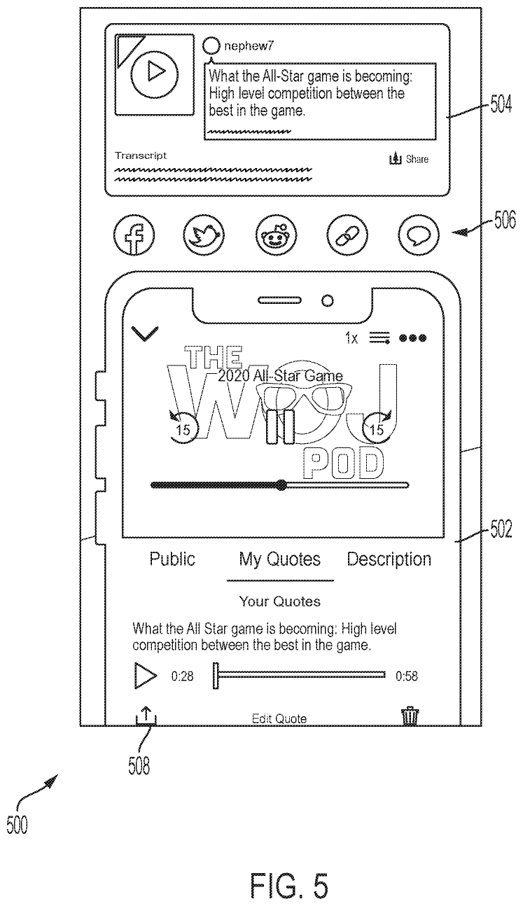

At 340, once the starting and ending points are identified and the clip is created at 330, a sharable link to the clip is created. The link may be a URL, for example. The URL may be in the form [server URL]/quote/[clip ID]. The [server URL] may be a URL for a clip server, such as clip server 420 described below in reference to FIG. 4. The clip ID may be provided to the user's computing device by the clip server after receiving a clip creation request from the user's computing device as described above in reference to block 330. The link may thus be formed by the user's device and/or the clip server using a clip ID generated by the clip server. The user can then share the link with a second and/or multiple users at 350. Details of the sharing process are described below for exemplary embodiments in reference to FIG. 5.

FIG. 4 depicts a system for creating a clip of a podcast according to various embodiments. System 400 includes a database 410 and a clip server 420 communicatively coupled to the database 410. The database 410 may be physically proximate to the clip server 420 or remote from the clip server 420. The clip server 420 may be implemented as a server computer communicatively coupled to the internet and including at least one electronic processor and at least one electronic persistent storage communicatively coupled to the at least one electronic processor. The at least one electronic persistent storage may store instruction that, when executed by the at least one electronic processor, perform clip server actions as described herein, e.g., as shown and described herein in reference to method 300 of FIG. 3. The clip server 420 may be implemented by its administrator using internet connected server hardware or may be implemented by another, e.g., as a cloud based server.

System 400 also includes a computing device configured by a clip client app as a clip client 430. Thus, the computing device includes at least one electronic processor and at least one electronic persistent storage communicatively coupled to the at least one electronic processor. The at least one electronic persistent storage of the computing device may store instruction that, when executed by the at least one electronic processor of the computing device, perform clip client actions as described herein, e.g., as shown and described herein in reference to FIGS. 1-6.

A user operating the clip client 430 executing a clip client app on a computer, cell phone, or tablet, for example, can create clips, send clips, and search for clips, for example by topic. The clip client app executing on the clip client 430 captures information about the podcast clip including any, or a combination, of: start time, end time, user ID, podcast ID, episode ID, and RSS link (e.g., for podcast server 440). The clip client app executing on the clip client 430 may further capture optional comments entered by the user, e.g., as text and/or audio. Further, the clip client app executing on clip client 430 conveys such clip and comment information to clip server 420. The clip client app executing on the clip client 420 may convey this data using any of a variety of protocols. Audio commentary may be implemented in any of a variety of formats, e.g., MP3, MP4, WAV, PCM, AIFF, etc.

The clip server 420 generates a link (e.g., a URL) corresponding to the podcast clip. As described above, the link may be in the form of a URL, such as [server URL]/quote/[clip ID], where [server URL] is a URL for clip server 420. The clip ID may be generated by clip server 420 and may be unique for each clip. The clip server 420 stores the [clip ID] portion in database 410 in association with the remaining clip data, including any, or a combination, of: start time, end time, user ID, podcast ID, episode ID, RSS link (e.g., for podcast server 440), any comment data, and any badge or icon data. The clip server 420 may then provide the link and/or clip ID to clip client 430. This completes the clip provision and generation process according to various embodiments.

The clip client 430 executing an instance of the clip client app, or any other clip client, may later access the clip, which causes the clip client 430 (or other client) to provide the clip ID to clip server 420, which retrieves clip data stored in database 410, e.g., using the clip ID as a key. Clip server 420 returns the clip data (e.g., in the form of a link) to the clip client 430, which connects to a podcast server 440 e.g., using the RSS link. Podcast server 440 retrieves the podcast starting at any identified start time and serves it to clip client 430. Podcast server 440 thus provides access to listen to the podcast. The clip client 430 then displays the clip on a presentation screen, such as presentation screen 200, which may include an audio or video player.

Note that the architecture presented in FIG. 4 is not limiting. According to some embodiments, the clip server 420 also functions as a podcast server 440 by retrieving and storing podcast episodes for which clips are generated. Such embodiments may operate as described above, except that when a clip is created by a clip client user, the clip server 420 may download and store the podcast episode in association with the clip ID. Later, when a user plays the clip, the audio from the podcast may be retrieved from the clip server 420 instead of the podcast server 440. This arrangement is particularly useful for podcasts that utilize dynamic advertisement insertion, as the clip system can better manage the advertisement timing.

FIG. 5 depicts clip sharing screens 500 according to various embodiments. The clip sharing screens 500 include a partial screenshot 504 representing a clip that has been shared, and a partial screenshot 502 representing a screen from the clip client app.

The partial screenshot 504 representing a clip that has been shared via URL 504 depicts a clip being played in a browser, for example. Thus, the partial screenshot 504 may include playback controls (e.g., play, pause, skip forward 30 seconds, skip backwards 30 seconds, etc.). Partial screenshot may also display a transcript of the clip, which may scroll as the clip plays.

Partial screenshot 502 represents a screen from the clip client app executing on a user's computing device such as a mobile phone. The clip client app may include a podcast (audio) player according to various embodiments. The partial screenshot 502 thus shows a podcast player screen in the app where the user is able to control episode playback and also save a quote from an episode. Alternately, some embodiments may include a video player instead of, or in addition to, the podcast player.

In general, a user of the clip client may share a link to the clip (e.g., a URL) with any other individual, e.g., through the clip client app or as a stand-alone URL. Thus, the app may include a sharing button 508 or other control for sending clips to other users of the app or elsewhere. Clips may be shared person-to-person to another clip client app user, shared publicly to any user of the app, or shared outside of the app by sending the URL via email, text, etc. Further, clips may be shared to social media applications 506, such as FACEBOOK, TWITTER, REDDIT, or sent via SMS. Icons for such social media and other sharing applications may be displayed when the user activates the sharing button 508, and the user may click on such an icon to share a clip via the selected communication channel. Alternately, the link may be copied and pasted into an email or other communication channel. Once shared, the second or multiple users can click on the link to listen to the clip. Optionally, the second or multiple users can listen to the rest of the podcast or the entire podcast after listening to the clip.

Note that some embodiments include a special clip-based social media network for obtaining and sharing clips. Each user of the clip client app may have a social media username and obtain a social media account. Accountholders may be able to search for other users and/or clips within the clip client app itself. (Searching for clips is not limited to social media account holders according to some embodiments.) Accountholders may subscribe to other users, such that when the other users create clips, the user is informed and/or the clips are presented. Examples of such searching are presented below in reference to FIG. 6. According to some embodiments, users may designate clips as public clips, which may be searched for and viewed by any other user, or as private clips, which may be kept private unless explicitly shared by the user.

FIG. 6 depicts a clip search screen 600 according to various embodiments. In general, some embodiments allow users to quickly find the most interesting or relevant parts of a podcast episode. Users are able to search for and consume the clips that others have created. The clip client app may thus include search functionality such that a user may search for clips based on any, or a combination, of clip creator, podcast, podcast episode, and category of podcast (e.g., APPLE podcast category). Such embodiments may search database 410 based on provided search term(s) and corresponding database column(s). Each clip may be stored with data that includes a caption and a transcription.

Thus, FIG. 6 depicts a clip search screen 600 that, as shown, includes depictions of the newest clips created by other users to which the viewing user has subscribed in the clip social network. The clip search screen 600 as depicted includes clickable tabs 602 for the newest clips as well as for displaying top-rated clips and the categories of “Basketball” and “Business.” The clip search screen 600 further includes a general clip search field 604 through which a user may enter search criteria for identifying a clip, a social media accountholder, a general user, a podcast, or a podcast episode. The search criteria may include data representing one or more of: clip creator, podcast, podcast episode, category of podcast (e.g., APPLE podcast category), clip, social media accountholder, or other user. The user may also search for and request clips based on the number of listens, the creator of the clip, or the originator of the audio content, e.g., the podcast host.

According to some embodiments, the clip client app presents recommended clips to its users. The recommendations may be based on popular clips among clip client app users (or clip social media accountholders). For example, if the user/accountholder frequently generates clips and comments on a particular podcast, or if the user/accountholder frequently consumes clips and comments on a particular podcast, then clips and comments for new episodes of the podcast, or new clips and comments on existing episodes, may be recommended.

Thus, various embodiment allow the user to quickly find the most interesting clips from all podcasts, e.g., organized by the type of content from the clip. The user can discover these clips through a graphical interface (e.g. using the general clip search field 604). Alternately, or in addition, the user is able to view or use a voice interface to request clips based on category of content. For example, the user may request clips from News, Sports, Entertainment, or other categories.

Once a user obtains a clip through searching or otherwise, they are able to view the number of times the clip has been viewed and a list of the other users who found the clip interesting. For a particular episode, a user is able to use his voice or a graphical user interface to request relevant quotes from that episode. For example, a user may request to listen to the most listened to clips, the newest clips, or clips from a particular user. After a user finishes listening to a clip, the user is able to keep listening to the source episode from where the clip ended.

Embodiments are not limited to audio podcasts. Some embodiments may allow users to generate and annotate (e.g., comment on) clips from other audio sources, such as audio books. Some embodiments may allow users to generate and annotate (e.g., comment on) clips of video. Such embodiments may operate as described herein, except instead of audio data, video data is identified, annotated (e.g., commented on), and processed.

Certain examples described above can be performed in part using a computer application or program. As used herein, a computer includes any device with a microprocessor including, but not limited to a desktop or laptop computer, a cellular device, and tablets. The computer program can exist in a variety of forms, both active and inactive. For example, the computer program can exist as one or more software programs, software modules, or both, that can be comprised of program instructions in source code, object code, executable code or other formats, firmware program(s), or hardware description language (HDL) files. Any of the above can be embodied on a computer readable medium, which can include computer readable storage devices and media in compressed or uncompressed form. Exemplary computer readable storage devices and media include conventional computer system RAM (random access memory), ROM (read-only memory), EPROM (erasable, programmable ROM), EEPROM (electrically erasable, programmable ROM), and magnetic or optical disks or tapes.

While the present teachings have been illustrated with respect to one or more implementations, alterations and/or modifications can be made to the illustrated examples without departing from the spirit and scope of the appended claims. For example, it will be appreciated that while the process is described as a series of acts or events, the present teachings are not limited by the ordering of such acts or events. Some acts can occur in different orders and/or concurrently with other acts or events apart from those described herein. For example, steps of the methods have been described as first, second, third, etc. As used herein, these terms refer only to relative order with respect to each other, e.g., first occurs before second. Also, not all process stages may be required to implement a methodology in accordance with one or more aspects or implementations of the present teachings. It will be appreciated that structural components and/or processing stages can be added or existing structural components and/or processing stages can be removed or modified. Further, one or more of the acts depicted herein can be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items can be selected. As used herein, the term “one or more of” with respect to a listing of items such as, for example, A and B, means A alone, B alone, or A and B. The term “at least one of” is used to mean one or more of the listed items can be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed can be somewhat altered, as long as the alteration does not result in nonconformance of the process or structure to the illustrated implementation. Finally, “exemplary” indicates the description is used as an example, rather than implying that it is an ideal. Other implementations of the present teachings will be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A method of providing a clip of a podcast episode by a podcast clip server, the method comprising:
receiving, by the podcast clip server and from a first instance of an app executing on a computing device, a request to generate a clip of a podcast episode, the request comprising data identifying the clip of the podcast episode;
generating a clip ID corresponding to the data identifying the clip of the podcast episode;
storing in persistent electronic memory the clip ID in association with the data identifying the clip of the podcast episode; and
providing at least the clip ID to the first instance of the app executing on the computing device, whereby a user of the first instance of the app executing on the computing device obtains a link to the clip of the podcast episode.

2. The method of claim 1, wherein the data identifying the clip of the podcast episode comprises: a podcast episode ID, an identification of a temporal starting point within the podcast episode, and an identification of a temporal ending point within the podcast episode.

3. The method of claim 1, wherein the data identifying the clip of the podcast episode comprises an RSS link to a podcast server that hosts the podcast episode.

4. The method of claim 1, further comprising:
receiving a request, by the podcast clip server and from a second instance of the app executing on a second computing device, for the podcast clip, wherein the request comprises the podcast clip ID;
retrieving the data identifying the clip of the podcast episode; and
providing the data identifying the clip of the podcast episode to the second instance of the app executing on a second computing device.

5. The method of claim 1, wherein the request further comprises commentary on the podcast clip, the method further comprising storing in persistent electronic memory the commentary on the podcast clip in association with the data identifying the clip of the podcast episode.

6. The method of claim 5, wherein the commentary comprises audio commentary.

7. A system for providing a clip of a podcast episode by a podcast clip server, the system comprising a podcast clip server communicatively coupled to a computer network and configured to perform operations comprising:
receiving, from a first instance of an app executing on a computing device, a request to generate a clip of a podcast episode, the request comprising data identifying the clip of the podcast episode;
generating a clip ID corresponding to the data identifying the clip of the podcast episode;
storing in persistent electronic memory the clip ID in association with the data identifying the clip of the podcast episode; and
providing at least the clip ID to the first instance of the app executing on the computing device, whereby a user of the first instance of the app executing on the computing device obtains a link to the clip of the podcast episode.

8. The system of claim 7, wherein the data identifying the clip of the podcast episode comprises: a podcast episode ID, an identification of a temporal starting point within the podcast episode, and an identification of a temporal ending point within the podcast episode.

9. The system of claim 7, wherein the data identifying the clip of the podcast episode comprises an RSS link to a podcast server that hosts the podcast episode.

10. The system of claim 7, wherein the operations further comprise:
receiving a request, from a second instance of the app executing on a second computing device, for the podcast clip, wherein the request comprises the podcast clip ID;
retrieving the data identifying the clip of the podcast episode; and
providing the data identifying the clip of the podcast episode to the second instance of the app executing on a second computing device.

11. The system of claim 7, wherein the request further comprises commentary on the podcast clip, and wherein the operations further comprise storing in persistent electronic memory the commentary on the podcast clip in association with the data identifying the clip of the podcast episode.

12. The system of claim 11, wherein the commentary comprises audio commentary.

13. A computer-implemented method of creating a clip of a podcast episode, the method comprising:
receiving at least one instruction from a user to generate the clip of the podcast episode, the at least one instruction comprising an identification of a starting point within the podcast episode and an identification of an ending point within the podcast episode;
sending to a podcast clip server a request to generate the clip of the podcast episode, the request comprising data identifying the clip of the podcast episode, the data identifying the clip of the podcast episode comprising the identification of the starting point within the podcast episode, and the identification of the ending point within the podcast episode, whereby the podcast clip server generates a clip ID and stores the clip ID in persistent electronic memory in association with the data identifying the clip of the podcast episode;
receiving, from the podcast clip server, the clip ID; and
converting the clip ID to a link to the clip of the podcast episode.

14. The method of claim 13, wherein the data identifying the clip of the podcast episode comprises: a podcast episode ID.

15. The method of claim 13, wherein the data identifying the clip of the podcast episode comprises an RSS link to a podcast server that hosts the podcast episode.

16. The method of claim 13, further comprising:
receiving an instruction from the user to forward the link to the clip of the podcast episode to a user of the app;
forwarding, in response to the receiving the instruction, at least the podcast clip ID to the user of the app.

17. The method of claim 13, wherein the request further comprises commentary on the podcast clip.

18. The method of claim 17, wherein the commentary comprises audio commentary.

19. The method of claim 13, further comprising displaying an at least partial transcript of the podcast episode, wherein the identification of the starting point within the podcast episode comprises an identification of the starting point within the podcast episode on the at least partial transcript, and wherein the identification of the ending point within the podcast episode comprises an identification of the ending point within the podcast episode on the at least partial transcript.

20. The method of claim 19, wherein the receiving the at least one instruction from the user to generate the clip of the podcast episode comprises receiving from the user a selection of a portion of the at least partial transcript of the podcast episode, wherein the starting point within the podcast episode comprises a beginning of the selection, and wherein the ending point within the podcast episode comprises an ending of the selection.

21. The method of claim 13, wherein the receiving the at least one instruction from the user to generate the clip of the podcast episode comprises receiving at least one instruction via a voice interface.

22. The method of claim 13, wherein the operations further comprise:
receiving search criteria from the user; and
displaying an identification of at least one podcast clip that matches the search criteria.

23. The method of claim 13, wherein the operations further comprise:
displaying a plurality of podcast clip categories;
receiving a selection of at least one podcast clip from the user based on at least one category of the plurality of podcast clip categories; and
providing the at least one podcast clip to the user.

24. An electronic system for creating a clip of a podcast episode, the electronic system comprising at least one electronic processor and at least one electronic persistent memory communicatively coupled to the at least one electronic processor and storing computer readable instructions that, when executed by the at least one electronic processor, configure the at least one electronic processor to perform operations comprising:
receiving at least one instruction from a user to generate the clip of the podcast episode, the at least one instruction comprising an identification of a starting point within the podcast episode and an identification of an ending point within the podcast episode;
sending to a podcast clip server a request to generate the clip of the podcast episode, the request comprising data identifying the clip of the podcast episode, the data identifying the clip of the podcast episode comprising the identification of the starting point within the podcast episode, and the identification of the ending point within the podcast episode, whereby the podcast clip server generates and a clip ID and stores the clip ID in persistent electronic memory in association with the data identifying the clip of the podcast episode;
receiving, from the podcast clip server, the clip ID; and
converting the clip ID to a link to the clip of the podcast episode.

25. The system of claim 24, wherein the data identifying the clip of the podcast episode comprises: a podcast episode ID.

26. The system of claim 24, wherein the data identifying the clip of the podcast episode comprises an RSS link to a podcast server that hosts the podcast episode.

27. The system of claim 24, wherein an app comprises the computer readable instructions, and wherein the operations further comprise:
receiving an instruction from the user to forward the link to the clip of the podcast episode to a user of the app;
forwarding, in response to the receiving the instruction, at least the podcast clip ID to the user of the app.

28. The system of claim 24, wherein the request further comprises commentary on the podcast clip.

29. The system of claim 28, wherein the commentary comprises audio commentary.

30. The system of claim 24, wherein the operations further comprise displaying an at least partial transcript of the podcast episode, wherein the identification of the starting point within the podcast episode comprises an identification of the starting point within the podcast episode on the at least partial transcript, and wherein the identification of the ending point within the podcast episode comprises an identification of the ending point within the podcast episode on the at least partial transcript.

31. The system of claim 30, wherein the receiving the at least one instruction from the user to generate the clip of the podcast episode comprises receiving from the user a selection of a portion of the at least partial transcript of the podcast episode, wherein the starting point within the podcast episode comprises a beginning of the selection, and wherein the ending point within the podcast episode comprises an ending of the selection.

32. The system of claim 24, wherein the receiving the at least one instruction from the user to generate the clip of the podcast episode comprises receiving at least one instruction via a voice interface.

33. The system of claim 24, wherein the operations further comprise:
receiving search criteria from the user; and
displaying an identification of at least one podcast clip that matches the search criteria

34. The system of claim 24, wherein the operations further comprise:
displaying a plurality of podcast clip categories;
receiving a selection of at least one podcast clip from the user based on at least one category of the plurality of podcast clip categories; and
providing the at least one podcast clip to the user.
